(19) United States
(12) Patent Application Publication
(10) Pub. No.: US 2008/0306780 A1
(43) Pub. Date: Dec. 11, 2008

(54) Method for internet supported and completion of travel services

(76) Inventor: Roland Schirra, Friedrichsdorf (DE)

Correspondence Address: DENNISON, SCHULTZ & MACDONALD, 1727 KING STREET, SUITE 105, ALEXANDRIA, VA, 22314, US

(21) Appl. No.: 11/808,433

(22) Filed: Jun. 11, 2007

(51) Int. Cl. G06Q 10/00

(52) U.S. Cl. 705/5

(57) ABSTRACT

A travel selection and booking system is provided, that facilitates the selection of different travel offerings for the customer, realizes better utilization of capacities and often avoids cancellations and otherwise necessary re-bookings. This is achieved by offering a dynamic, customized internet site to each individual traveler, with pre-defined specifications given by his company or travel agent. In it he defines and arbitrarily changes his travel preferences and actual requests. Processed with an integrated parametric search engine, tour propositions and itineraries can be generated, evaluated and refreshed, so to allow easy research for options and updating or final booking.

### BACKGROUND OF THE INVENTION

1. Field of the Invention

The present invention relates to a travel selection and booking system, that eases the choice of different services to customers, allows better utilization of capacities for contractors and tendering parties and largely avoids cancellations and re bookings.

“Classical” models for travel reservations, both for holidays as well as for business trips, today hardly meet the requirements of customers and service providers.

Whereas formerly a predominant number of holidays reservations were booked as package offers from tour operators, an increasing variety of single offers and enlarged price transparency in the internet has changed the selection behavior of users and promoted individual composition of elements therefore.

However, it is a real challenge for customers to select this information, coming from a multiplicity of heterogeneous sources, for their relevant information and optimize it with personal preferences and restrictions.

So, for example, airline reservation databases contain about 20 fields of flight related data and 35 rules for each flight, to be matched with the requirements and intentions of customers. The routine of experienced personal allows fast completion of this task, however often at a suboptimal match, whereas customers themselves would feel swamped with this influx of data.

Consequently, large amounts of information and selectable criteria must remain inaccessible to customers in the internet, in order let them keep track.

Besides, the alignment of so much data slows down communication or requires higher bandwidth and server systems with enlarged capacity. So hitherto access time to information sources is seen to be increasingly unsatisfactory.

A particular problem is the overview of the availability of individual offerings and their co-ordination in changing temporal operational sequences.

Particularly the necessity to restart the procedure with all data for each new offer or each new date after finalizing an inquiry makes the handling cumbersome.

On the other hand the planning of contractors and tendering parties is plagued by increasingly short term reservations and changes of dates and destinations, resulting in largely wasted capacities.

Furthermore, travel intermediaries are, due to increased cost consciousness of their professional customers, much less frequently overall assigned, whereas companies increasingly prefer to compose business trips themselves from economical elements, found in the internet.

Accordingly, contractors and tour operators are forced to market capacities, otherwise booked, en bloc, dynamically.

Consequently, all travel intermediaries are challenged with differentiating their offers by increased cross-linking with competitors, thus diminishing firmly booked contingents and replacing it by short term reservations as well as to stabilize their yields by gaining arbitrage profits.

Generally this leads to greater variety in offerings, but requires a more sophisticated booking management and, in case of poor optimization strategies, can lead to substantial losses.

However, existing booking systems, based on habitual commercial systems for travel services did not keep up with the necessary flexibility and dynamics for these kinds of business.

2. Description of Related Art

There are a variety of methods known, to facilitate travel operation:

In patent literature quite a few propositions refer to selective advancements, so U.S. Pat. No. 5,191,523 to ease the finding of cost and time information by professional travel operators. Others would decompose user enquiries into information requests to different data providers, as in U.S. Pat. No. 6,834,229, or source and deliver such data in a report to consumers, as in U.S. Pat. No. 6,842,737.

For general solution, U.S. Pat. No. 4,862,357 presented a system, where travel data could be accessed from a local computer terminal, sorted and scored in accordance to a predetermined travel policy, so to put out a variety of optional personal travel offers and itineraries.

But this implies that the whole system is kept on the personal computer of the traveler, to be connected to travel data providers through conventional communications, what seems hardly viable.

U.S. Pat. No. 6,018,715 teaches a solution, where travel operators keep files on their customers (“Business Entity Portfolios”), like travel agencies and on the latter's individual customers (“Traveller Portfolios”) with all preferences and restrictions for travel, by which it generates individual travel offers and itineraries on request.

Apart from the fact, that it seems hardly feasible to receive and constantly refresh said data, this system does not enable the final customers to survey different offers and options themselves and preferably online, which is the crucial point in actual business operation.

On the other hand, numerous travel portals have emerged in the internet that promise to select best offers for any kind of travel. But except detailed information on destinations and hotels, these usually only link to particular offers of airlines, tour operators or hotel reservation systems, selected by automated search tools (“agents” or “bots”).

Hitherto all these reservation systems are designed for finalizing bookings after selecting a set of available offers. Thus changes are frequently only possible with a pedantic procedure of cancellation and filing a new reservation.

As far as personalized search profiles are stored by these sites, there is growing concern about commercialization (third-party data mining) and misuse of personal and business data, which lead to company policies, restricting the use of these services.

Alternatively, in U.S. Pat. No. 6,993,554 Boeing offers a system, that would allow the traveler not only to identify and to store and arbitrarily modify a user-defined profile and content layout, including personal traveling preferences, on a secured level. Even more advantageous would be that changing reservations would be possible, even while traveling, by access through different integrated portals from home and on travel.

This system, however, obviously could not jet be realized, possibly due to the problem of necessarily integrating parties with strongly diverging interests.

### BRIEF SUMMARY OF THE INVENTION

An object of the present invention therefore is to design the operation in a way that does not need to change common reservation and booking systems, but would make and keep all current options available to the traveler until finalizing his planning, without unnecessary blocking capacities and without repeatedly running through cumbersome data collecting routines.

The objects of the invention can be accomplished by avoiding just a static offer matching to the queried preferences of the user which he only could accept or reject, as usual in conventional travel systems.

Instead, a travel intermediary or service provider offers a secured own internet page for each customer and subsequently each traveler, accessible through his system. This site can be customized to the user's and/or his company or agent's standards and preferences and arbitrarily modified.

The main element is a travel planning module which the user can complete, and later modify, with his individual request. A parametric search engine, fed from the planning module, returns the results to the traveler's site and a subsequent booking engine allows him to book, print his ticket or codes himself and leads back to the service provider's system for billing.

When installed and customized, the traveler can put in his or her actual travel demand and get a set of offers and itineraries from the search engine, basically in the standard way known in the art (see e.g. U.S. Pat. No. 4,862,357). The user can then arbitrarily edit the request himself and by pushbutton-action, again relate the search engine through the provider's system to suitable offers from different sources—as e.g. from conventional reservation systems.

Thus the available capacities are always queried and adjusted according to the customer's preferences, without repeated input of already given data.

Since usually most data remain unchanged, updated offers can thus be achieved with much less effort, and, as long as standard offers are only varied in a few criteria (e.g. another day, but same flight number), much less data traffic is generated.

Now the user can decide, watching the dynamic change of repeatedly requested offers, at what time to finalize a booking or e.g. risk the loss of an attractive offer or travel date.

In case, however, next-best offers as to given preferences can be presented effortless and almost immediately and transferred to the booking engine by a single action of the user.

It further is the object of the present invention to supply added value for using the above described system when establishing travel itineraries in the way given.

So with multiple changes within dates of travel and flight schedules, which can easily be changed without final booking, or a selected time spread, the search engine can acquire data to survey developments in prices and capacities, for to indicate these trends and to put out warnings for expiring good offers or shortcoming capacities.

Furthermore actual and long-range weather forecasts, collected from third party providers can be added with simple symbols to overviews and itineraries, particularly with respect to arrival time and dwell, so to ease up decision on choices on the schedule and for planning on forthcoming travel means, proper clothing, etc.

Another valuable helper for planning can be added using already available data, when impositions due to jet lag and predictable deficits in sleeping time are encountered. Since different local times are known, consequences can be symbolized—preferably after inquiring for personal responsiveness in the travel preferences dialogue—or indicated in terms of probable percentage of fitness or handicap at each day of arrival, dwell and return. This might be helpful in planning crucial appointments and suitable times of relaxation.

Finally it is to be understood, that all associated parties will be interested in keeping their business conditions and preferences confidential. The company might not like to reveal all regulations, travel policies, and restrictions, differentiated in ranking managers and functions. Neither the agent, nor the service provider would like to reveal their interests and conditions, and particularly the traveler would not risk putting in very personal preferences and possible handicaps, if his boss had access to it.

With coding and available securing means, the system therefore provides an optimum selection of travel choices on conditions given, without letting them be recognized as constrictive limitations.

### BRIEF DESCRIPTION OF THE DRAWINGS

FIG. 1 is a schematic view of a system in accordance with the present invention, wherein the system is basically exemplified in a flowchart.

### DETAILED DESCRIPTION OF THE INVENTION

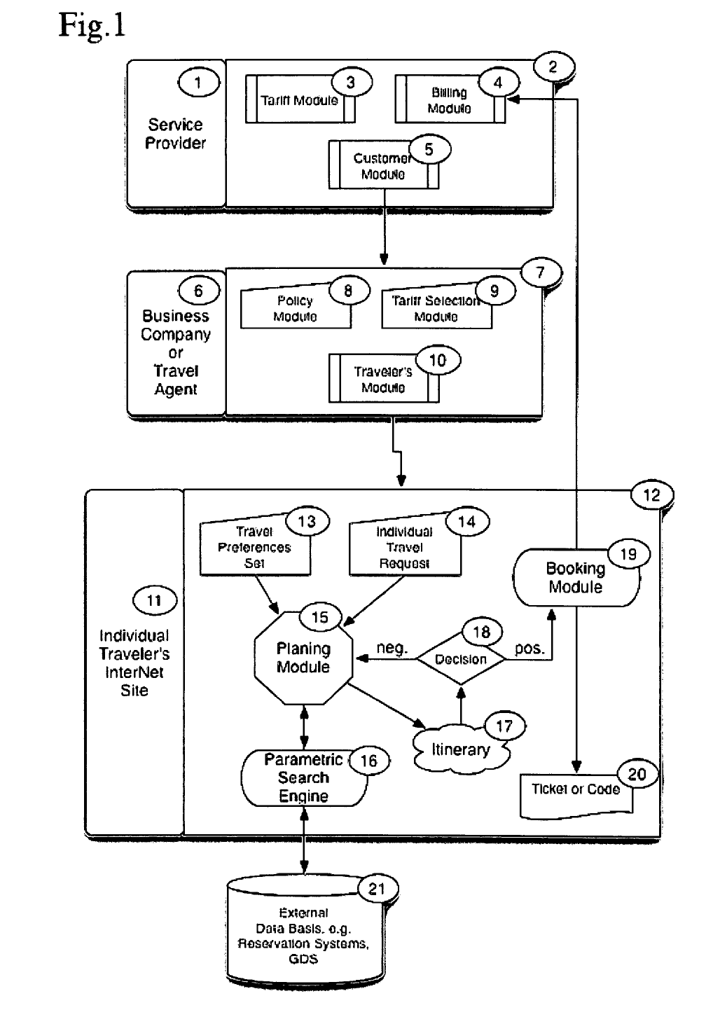

As seen from FIG. 1, the system contains the part of the service provider 1, keeping a data system 2, which consists of a tariff module 3, a billing module 4 and a customer module 5, which one he is providing to his clients, e.g. companies with own staff for business travels or travel agents 6.

Said module, now being 7, incorporates further modules as policy module 8 and tariff selection module 9 for these clients 6 to define policies and restrictions for their travelers within.

It furthermore incorporates a traveler's module 10, which these clients 6 hand over to their individual travelers 11, to become the latter's internet site 12 with another set of modules to work out their travels.

These contain a travel preference set 13, by which each traveler can define his preferred travel arrangement (like means of travel, choice of airlines, seats, stations or airports of departure an arrival, hotel group, etc.) within the travel policy 8 and ascribed tariffs 9 of his company or travel agent 6.

The travel preference set 13 is joint with another questionnaire 14, defining the individual travel request, which together are to become the input to the central element, a planning module 15. Said planning module is working via a parametric search engine 16 to find adequate offers from external data basis 21, which may be hotel register companies or hotel groups, tour operators and car rental groups etc, listed within the policy module 8 at conditions of tariff module 3, or accordingly global service distributors for airlines and contractors like Amadeus, Sabre and Gallileo.

The abovementioned planning module 15 then generates a first itinerary 17, that is iterative altered as to the correcting inputs of the traveler, until he or she is content and passes the set to the booking module 19. This one leads to printing the ticket or equivalent code 20, books through the channels predefined by the service provider 1 and spools it back to be processed through his billing module 4.

It is to be understood, that this schema is meant to be exemplarily and may be subject to change under different working conditions, operational rules or legacies.

As also seen from FIG. 1, the service provider 1 is offering a set of customer services 7 and 12 to companies and travel agents 6, which can be customized by these with a policy module 8 and a tariff selection module 9. It further contains a traveler's module 10 in the form of a secured individual internet or intranet site 12, which the intermediary is forwarding to his traveling parties or client travelers.

This site is designed to install further functional modules prepared by the service provider 1: The individual traveler can customize his site with the travel preferences set 13 and then use the individual travel request module 14 to feed the planning module 15 for generating booking requests to a parametric search engine 16 to fetch offers and travel data from external data basis 21, like reservation systems and global data sources (if necessary, routed through the service provider's network). These results are spooled back to the planning module 15 and, after a possible iterative optimization process, result in a travel plan or itinerary 17. Without much effort the traveler can now approve or change 18 this plan any time before final booking.

If rejected, the complete set of data remains accessible on the traveler's internet site 12.

It can later be changed in every single point and again submitted to the search engine 16 to confirm the consecutive “bookability” of the former set together with these new options. So the traveler himself can keep track of changing offers for his set without renewing all procedures and in case of void offers get one or more of the options that come closest to his or her needs.

When decided, the traveler activates the booking module 19 to make reservations, issue tickets or ticket codes 20 and transmits these data to the billing module 4 in the service provider's system.

A preferred embodiment has been described in detail and a number of alternatives have been considered. As changes in or additions to the above-described embodiments may be made without departing from the nature, spirit or scope of the invention, the invention is not to be limited by or to those details, but only by the appended claims or their equivalents.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modification and equivalents may be resorted to, falling within the scope of the invention.

What is claimed is:

1. A method for an internet-supported selection and completion of travel services, comprising a traveler's own internet or intranet site, prepared by a service provider, which contains modules, customized by his company or travel agent, for individually searching offers and travel data.

2. A method according to claim 1, wherein the search is routed through the service provider's network.

3. A method according to claim 1, comprising a parametric search module, that links the predefined searches to the provider's and external third party data basis.

4. A method according to claims 1 to 3, wherein all data received are stored on the individual internet page and remain directly accessible.

5. A method according to claims 1 to 4, wherein all individual travel preferences and travel requests can be arbitrarily modified.

6. A method according to claims 1 to 5, wherein refreshing requested data after time and due to changes in preferences or request can be achieved at the push of a button.

7. A method according to claims 1 to 5, wherein an actual survey of capacities on requested services is acquired by analysis of developments in offers and requests and can be displayed with easily apprehensible charts or symbols.

8. A method according to claims 1 to 5, wherein an actual survey of price development on requested services is acquired by analysis of developments in offers and can be displayed with easily apprehensible charts or symbols.

9. A method according to claims 1 to 5, wherein the planning module is extendible with weather forecasts, linked in from third party providers.

10. A method according to claim 9, wherein the predictable weather is indicated with small symbols and indication of temperatures.

11. A method according to claims 1 to 5, wherein the planning module contains a jet-lag-prognosis and -avoidance module, indicating probable deficits in fitness and lack of sleeping time at each destination and on return.

12. A method according to claim 11, wherein predictable fitness is indicated using symbols and/or percentage of creative or working ability on each day of arrival, dwell or return.

13. A method according to claim 1, wherein the individual user's site and all other modules are secured and coded according to actual standards—so that only the user, his company or travel agent and the service provider's can get access to data which is either their own or necessary for booking, billing and revision.
